(19) United States
(12) Patent Application Publication
(10) Pub. No.: US 2021/0027339 A1
(43) Pub. Date: Jan. 28, 2021

(54) SYSTEM AND METHOD FOR DETERMINING KEY WORDS RELATED TO PRODUCT SAFETY ISSUES

(71) Applicant: Walmart Apollo, LLC, Bentonville, AR (US)

(72) Inventor: Debanjana Banerjee, Kolkata (IN)

(21) Appl. No.: 16/936,668

(22) Filed: Jul. 23, 2020

Related U.S. Application Data
(60) Provisional application No. 62/901,306, filed on Sep. 17, 2019.

(30) Foreign Application Priority Data
Jul. 24, 2019 (IN) 201941029843

(51) Int. Cl. G06Q 30/02; G06F 40/35; G06K 9/62

(52) U.S. Cl. CPC G06Q 30/0281; G06Q 30/0282; G05D 1/0088; G06K 9/6259; G06F 40/35

(57) ABSTRACT

A set of reportable customer cases is obtained, and a set of non-reportable cases is obtained from un-labeled customer cases. Matrices of words from the non-reportable set and reportable set are obtained. A comparison is made between the reportable corpus and the non-reportable corpus. For words that are in the reportable corpus and not in the non-reportable corpus more than a predetermined number of times, words are identified as core keywords and put it in a keyword set. Iterations are performed on the set to refine the set and improve its accuracy and create a dictionary using both lexicon and contextual nearness of words.

### CROSS-REFERENCE TO RELATED APPLICATIONS

This application claims the benefit of Indian Provisional Application No. 201941029843, filed Jul. 24, 2019, and U.S. Provisional Application No. 62/901,306, filed Sep. 17, 2019, both of which are incorporated herein by reference in their entireties.

### TECHNICAL FIELD

These teachings relate to determining key words related to product safety issues in, for example, complaints sent by customers.

### BACKGROUND

Product safety is important to consumers of products. Various hazards relating to the products exist. For example, products may explode, catch on fire or leak. It is desirable that these issues be avoided.

Safety issues occur infrequently compared to other types of incidents. Although occurring relatively infrequently, there are a large number of types including fire hazard types, drowning hazard types, biological hazard types, and breakage types to mention a few examples. This sometimes makes it difficult to address product safety issues.

### BRIEF DESCRIPTION OF THE DRAWINGS

The above needs are at least partially met through the provision of approaches for obtaining key words from customer communications, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings;

FIG. 4 comprises a diagram of a system as configured in accordance with various embodiments of these teachings;

FIG. 5 comprises a flowchart as configured in accordance with various embodiments of these teachings.

### DETAILED DESCRIPTION

Generally speaking, a small set of reportable customer cases and a set of un-labeled customer cases are available. First, a group of non-reportable cases from the un-labeled cases is identified. In examples, this is performed using positive un-labeled (PU) classification learning approaches using the metric and vector distances. Second, a corpus (e.g., matrix or table) of words from the non-reportable set and a corpus from the reportable set are obtained. These show the frequency of words. Third, a comparison is made between the reportable corpus and the non-reportable corpus. For words that are in the reportable corpus and not in the non-reportable corpus more than a predetermined number of times, words are identified as an initial core keyword and put it in a keyword set. Fourth, iterations are performed on the set to refine the set and improve its accuracy. By this, words that might be in the reportable or non-reportable set, or words that are globally “close” or considered for inclusion in the set. Various approaches can be used to determine whether to include new words. When the iterations do not change the set anymore, then a final dictionary is determined. New customer cases are applied to the dictionary and if the number of words in the case are greater than a threshold, an action can be taken.

It will be appreciated that both contextual word embedding and global word embedding are used to obtain the dictionary. The purpose of this is to expand the set of keywords beyond the data available for training. The iterations are run to improve exhaustiveness; if the iterative clustering around core keywords are run enough number of times, it will provide a near exhaustive dictionary.

In many of these embodiments, a system includes a retail store, a user electronic device, an electronic communication network, a database, and a control circuit. The retail store includes an employee and an automated vehicle. The electronic communication network is coupled to the user electronic device.

The database is disposed at a central location. The database includes a small set of reportable customer cases. By “small,” it is meant many times less than the set of un-labeled or available cases. Each set of reportable customer cases is labeled as reportable and are customer-reported communications having verified safety concerns that are reportable to an authority. The database also includes a set of un-labeled customer cases. The un-labeled customer cases are not labeled as either reportable or non-reportable.

The control circuit is disposed at the central location. The control circuit is coupled to the database and the electronic communication network. The control circuit is configured to, for each case in the set of un-labeled customer cases, determine a metric, wherein the un-labeled customer cases are customer-reported communication from a customer has an associated type, the metric being a summation of a sentiment score and a similarity score (lexicon similarity with the set of reportables).

The control circuit is further configured to identify, using a positive un-labeled (PU) classification learning approach, a set of non-reportable customer cases from the set of un-labeled customer cases based upon the type of case, the metric, and vector distances between cases in the set of un-labeled customer cases and cases in the set of reportable customer cases.

The control circuit is additionally configured to, using the set of non-reportable customer cases, create a non-reportable matrix, the non-reportable matrix having a frequency of words in the set of non-reportable cases, and store the non-reportable matrix in the database. The control circuit is further configured to, using the set of reportable cases, creating a reportable matrix, the reportable matrix having a frequency of words in the set of reportable cases, and store the reportable matrix in the database.

The control circuit is still further configured to compare words in the reportable matrix to words in the non-reportable matrix, and for any word that appears in the reportable matrix and not in the non-reportable matrix more than a predetermined amount of times, add the word as an initial keyword in a keyword set, the keyword set comprising one or more so-identified (core) keywords.

The control circuit is yet further configured to form a dictionary by iterating on the keyword set, the iterating forming clusters around keywords in the keyword set, the iterating, at each iteration, determining whether to add or delete keywords from the keyword set and re-computing the (core) keywords.

The control circuit subsequently receives a new customer case entered by a user via the user electronic device, determines words in the new customer case, compares the words in the new customer case to words in the dictionary, and, determines an action based upon the comparison. The action is one or more of sending an electronic message to an employee in a store to investigate, sending a first control signal to the automated vehicle to investigate, or sending a second control signal to the automated vehicle to remove the product from the store.

In aspects, the type of case is a compliment, a suggestion, an enquiry, a product performance review, a property damage report, or a complaint. Other examples are possible.

In some examples, the sentiment score relates to an emotional strength of words, the emotional strength of each of the words being set to predetermined value. In other examples, the similarity score is the average semantic distance between a case in the un-labeled set of customer cases and a case in the set of reportable customer cases. Other examples are possible.

In some other aspects, the iterating obtains potential keywords to add to the keyword set by consulting the reportable matrix to words and the non-reportable matrix using contextual word embedding. In yet other examples, the iterating obtains potential keywords to add to the keyword set by consulting a global embedding source. In still other aspects, the iterating continues until successive iterations produce identical results.

In other examples, the automated vehicle is an automated ground vehicle or an aerial drone. Other examples are possible.

In others of these embodiments, an automated vehicle is provided at a retail store, and the retail store includes an employee. A user electronic device and an electronic communication network are also provided. A database that is disposed at a central location is also provided. The database includes a small set of reportable customer cases. Each of the set of reportable customer cases is labeled as reportable and is a customer-reported communication having verified safety concerns that are reportable to an authority. The database also includes a set of un-labeled customer cases, and the un-labeled customer cases are not labeled as either reportable or non-reportable.

A control circuit disposed at the central location is also provided. At the control circuit and for each case in the set of un-labeled customer cases, a metric is determined. The un-labeled customer cases are customer-reported communication from a customer having an associated type, and the metric is a summation of a sentiment score and a similarity score.

At the control circuit, a positive un-labeled (PU) classification learning approach is used to identify a set of non-reportable customer cases from the set of un-labeled customer cases based upon the type of case, the metric, and vector distances between cases in the set of un-labeled customer cases and cases in the set of reportable customer cases.

At the control circuit and using the set of non-reportable customer cases, a non-reportable matrix is created. The non-reportable matrix has a frequency of words in the set of non-reportable cases and the non-reportable matrix is stored in the database.

At the control circuit and using the set of reportable cases, a reportable matrix is created. The reportable matrix has a frequency of words in the set of reportable cases and the reportable matrix is stored in the database.

At the control circuit, words in the reportable matrix are compared to words in the non-reportable matrix, and for any word that appears in the reportable matrix and not in the non-reportable matrix more than a predetermined amount of times, the word is added as an initial keyword in a keyword set. The keyword set comprises one or more so-identified (core) keywords. These core keywords obtained act as the very initial points around which the first of the iterative clusters are formed. In successive iterations, the core keywords are re-computed based on relative local density measures and the clusters are re-run around the newly obtained core keywords.

At the control circuit, a dictionary is formed by iterating on the keyword set. The iterating forms clusters around keywords in the keyword set. The iterating, at each iteration, determines whether to add or delete keywords from the keyword set and re-computes the (core) keywords.

The control circuit subsequently receives a new customer case entered by a user via the user electronic device, determines words in the new customer case, compares the words in the new customer case to words in the dictionary, and, determines an action based upon the comparison. The action is one or more of sending an electronic message to an employee in a store to investigate, sending a first control signal to the automated vehicle to investigate, or sending a second control signal to the automated vehicle to remove the product from the store.

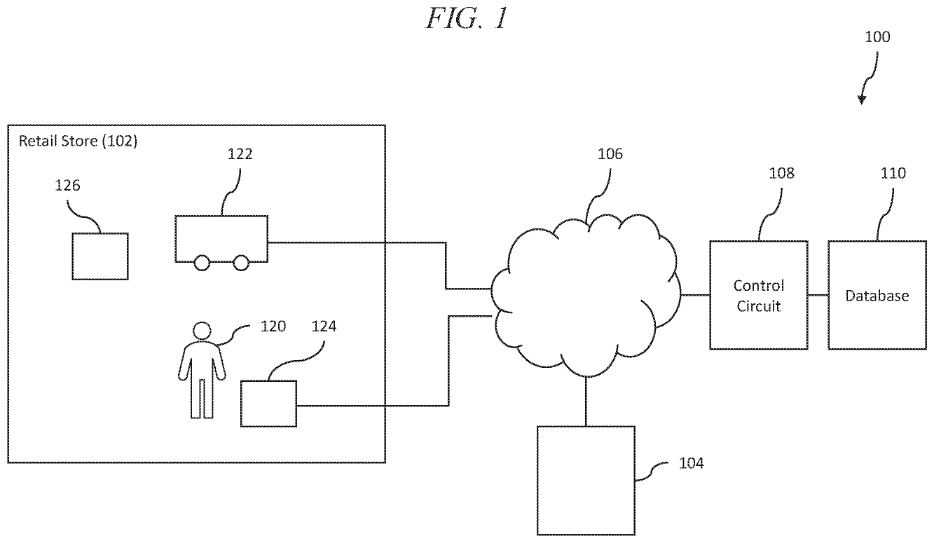

Referring now to FIG. 1, a system 100 for determining key words related to product safety issues includes a retail store 102, a user electronic device 104, an electronic communication network 106, a database 110, and a control circuit 108. The retail store 102 includes an employee 120 and an automated vehicle 122. The electronic communication network 106 is coupled to the user electronic device 104, the automated vehicle 122, and an electronic device 124 utilized by the employee 120.

The database 110 is disposed at a central location. The database 110 includes a set of reportable customer cases. Each of the set of reportable customer cases is labeled as reportable and are customer-reported communications having verified safety concerns that are reportable to an authority. The database 110 also includes a set of un-labeled customer cases. The un-labeled customer cases are not labeled as either reportable or non-reportable.

The retail store 102 may be any type of retail store selling any type of product and can also be a warehouse, distribution center, or members-only store. Other examples are possible.

In examples, the mobile electronic device 104 is a smart phone, a tablet, a cellular phone, a laptop computer, or a personal computer. Other examples are possible. The mobile electronic device 104 may be used by a customer to enter a case and the case may be a compliment, a suggestion, an enquiry, a product performance review, a property damage report, or a complaint to mention a few examples. Previous cases may have been entered by other electronic devices (or by some other approach) and stored in the database 104.

The electronic communication network 106 may be the internet, a wireless network, a cellular network, a wide area network, a local area network, or combinations of these or other networks. Other examples are possible.

In other examples, the automated vehicle 122 is an automated ground vehicle or an aerial drone. Other examples are possible. The automated vehicle 122 may include levers, grips, arms, suction grips, and other mechanical features that allow the vehicle 122 to navigate through the store and retrieve the products 126 from shelves. The product or products 126 may be any type of retail product sold to customers.

The control circuit 108 is disposed at the central location. The central location may be a company headquarters or home office to mention two examples. The control circuit 108 is coupled to the database 110 and the electronic communication network 106. It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is configured to, for each case in the set of un-labeled customer cases, determine a metric, wherein the un-labeled customer cases are customer-reported communication from a customer having an associated type, the metric being a summation of a sentiment score and a similarity score. In aspects, the type of case is a compliment, a suggestion, an enquiry, a product performance review, a property damage report, or a complaint. Other examples are possible.

In some examples, the sentiment score relates to an emotional strength of words, the emotional strength of each of the words being set to a predetermined value. In other examples, the similarity score is the average semantic distance between a case in the un-labeled set of customer cases and a case in the set of reportable customer cases. Other examples are possible.

The control circuit 108 is further configured to identify, using a positive un-labeled (PU) classification learning approach, a set of non-reportable customer cases from the set of un-labeled customer cases based upon the type of case, the metric, and vector distances between cases in the set of un-labeled customer cases and cases in the set of reportable customer cases.

The control circuit 108 is additionally configured to, using the set of non-reportable customer cases, create a non-reportable matrix, the non-reportable matrix having a frequency of words in the set of non-reportable cases, and store the non-reportable matrix in the database. The control circuit 108 is further configured to, using the set of reportable cases, create a reportable matrix, the reportable matrix having a frequency of words in the set of reportable cases, and store the reportable matrix in the database.

The control circuit 108 is still further configured to compare words in the reportable matrix to words in the non-reportable matrix, and for any word that appears in the reportable matrix and not in the non-reportable matrix more than a predetermined amount of times, add the word as an initial keyword in a keyword set, the keyword set comprising one or more so-identified (core) keywords.

The control circuit 108 is yet further configured to form a dictionary by iterating on the keyword set, the iterating forming clusters around keywords in the keyword set, the iterating, at each iteration, determining whether to add or delete keywords from the keyword set and re-compute the core keywords. In some other aspects, the iterating obtains potential keywords to add to the keyword set by consulting the reportable matrix to words and the non-reportable matrix. In yet other examples, the iterating obtains potential keywords to add to the keyword set by consulting a global embedding source. In still other aspects, the iterating continues until successive iterations produce identical results.

The control circuit 108 subsequently receives a new customer case entered by a user via the user electronic device 104, determines words in the new customer case, compares the words in the new customer case to words in the dictionary, and, determines an action based upon the comparison. The action is one or more of sending an electronic message to an employee in a store to investigate (via the device 124), sending a first control signal to the automated vehicle 122 to investigate, or sending a second control signal to the automated vehicle 122 to remove a product 126 from the store 102. It will be appreciated that these actions result in the interaction of physical components, for example, the movement and navigation through the retail store by the automated vehicle 122, the movement of products 126, and/or the alerting of the employee 120 to mention a few examples.

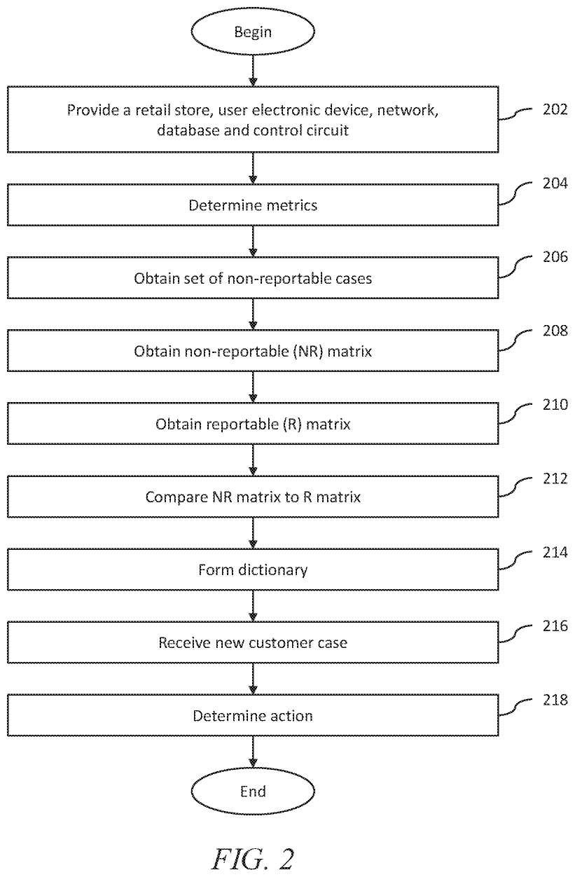

Referring now to FIG. 2, one example of an approach for identifying keywords in customer communications is described. At step 202, a retail store, user electronic device, electronic communication network, database, and control circuit are provided. The retail store includes an employee and an automated vehicle.

The database is disposed at a central location. The database includes a set of reportable customer cases. Cases may be any type of customer communication having a given type. For example, a customer may write a product review, send a compliment, or register a complaint. In some examples, the cases follow a predetermined format, while in other examples, the cases do not follow a predetermined format.

The set of reportable customer cases are labeled as reportable and are customer-reported communications having known safety concerns that are reportable to an authority. This classification may be accomplished previously and may be accomplished manually or automatically. The database also includes a set of un-labeled customer cases, and the un-labeled cases are not labeled as either reportable or non-reportable. The control circuit disposed at the central location and is coupled to the database and the electronic communication network.

At step 204, for each case in the set of un-labeled customer cases, a metric for each case is determined. The un-labeled customer cases are communications from a customer having an associated type (e.g., compliment or complaint). The metric is a summation of a sentiment score and a similarity score.

The sentiment score is obtained by sentiment analysis. In aspects, a lower sentiment score implies higher reportability. The similarity (or distance) score is the average distance between the paragraph vectors of the unlabeled cases and the reportable cases. As is known sentences and paragraphs in a communication (e.g., a case) can be represented as a vector. In aspects, a lower distance score implies higher reportability. In aspects, the Metric=Sentiment Score+Distance Score.

The higher value of the metric will imply lower reportability i.e., higher non-reportability. This metric along with paragraph embedding are used as features in a Positive Un-labeled (PU) learning algorithm to classify the complaint type of reviews into a reportable set and a non-reportable set.

At step 206, from the set of un-labeled customer cases and using a positive un-labeled (PU) classification learning approach, a set of non-reportable customer cases is identified based upon the type of case, the metric, and vector distances between cases in the set of un-labeled customer cases and cases in the set of reportable customer cases. In this step, a sample of negative (non-reportable) instances is obtained from the un-labeled cases.

In aspects, each case has a “type” identifier or column. A preliminary layer of selecting a non-reportable case is to use the Type column as a filter for the cases (type records whether the customer review is a Complaint, Compliment, Suggestion, Question, Review, and so forth). In some aspects, incidents pertaining to product safety will specifically lie under the Complaint type; hence all other types can automatically be used as non-reportable cases. The preliminary filter will identify very blatant (easy to identify) non-reportable cases. In aspects, one challenge is to identify non-reportable cases from the complaint type of cases.

At step 208 and using the set of non-reportable customer cases, a non-reportable corpus (e.g., matrix or table) is created. The non-reportable corpus has a frequency of words in the set of non-reportable cases, and the non-reportable corpus is stored in the database.

This table may be created in a variety of different ways. After initial cleaning of data (e.g., removing all stop words, punctuations, store-specific terms, etc. and lemmatizing (stemming) every word in the corpus to its root word), this word-frequency matrix is created.

At step 210 and using the set of reportable cases, a reportable corpus (e.g., matrix or table) is created. The reportable corpus has a frequency of words in the set of reportable case, and the reportable corpus is stored in the database. As with the non-reportable table, this table may be created in a variety of different ways. After initial cleaning of data (e.g., removing all stop words, punctuations, store-specific terms, etc. and lemmatizing (stemming) every word in the corpus to its root word), this word-frequency matrix is created.

At step 212, words in the reportable corpus are compared to words in the non-reportable corpus. For any word that appears in the reportable corpus and not in the non-reportable corpus more than a predetermined amount of times, the word is added as an initial (core) keyword in a keyword set, the keyword set comprising one or more so-identified keywords.

In this step, the task is to identify words that are peculiar to product safety. The system is looking for words that occur in the reportable cases and that do not occur in the non-reportable cases. The initial keywords are identified as any word that appears in the reportable corpus but does not appear in the non-reportable corpus more than K times. The value of K is pre-specified and usually is very low (e.g., 0 or close to 0). The keywords identified (core keywords) thus act as the initial core keywords and are the beginning of the dictionary.

At step 214, a dictionary is formed by iterating on the keyword set. The iterating forms clusters around keywords in the keyword set. The iterating, upon each iteration, determines whether to add or delete keywords from the keyword set and re-computes core keywords.

In aspects, the process of dictionary building is purely iterative. The entire vocabulary (both contextual and universal) is the population space. Initially, clusters are formed around each of the core keywords. The distance used for clustering is simply the distance between the embedding of the core keyword and a potential keyword. Once the first set of clusters are formed, the core keywords are re-computed via Relative Local Density and Direct Reachability approaches, which are known to those skilled in the art.

In aspects, a keyword is a core keyword if its Relative Local Density is higher than a given threshold or, it is directly reachable from another core keyword. Once the core keywords are re-computed, the clustering algorithm is re-executed. In this way, the system alternately iterates on computation of core keywords and clustering around the core keywords until two successive iterations produce near-similar results, i.e., the total set of words comprising the dictionary does not change beyond a limited value over two successive iterations.

The final dictionary, i.e., the set of defining keywords corresponding to the rare event, in this case product safety, is given by the union of the clusters around the core keywords of the immediate iteration.

In aspects, the final dictionary can be still further improved. For example, in a limited number of cases, there can be keywords corresponding to product safety that will be potentially missed and also keywords which are relatively unrelated to product safety may potentially be captured in the dictionary. To further improve these approaches, every suggested keyword is ranked by a degree of appropriateness, which is given by the relative local density of the keyword compared to the other keywords in the dictionary. The higher the relative local density of a keyword, the higher its appropriateness in context of the rare event.

At step 216, the control circuit subsequently receives a new customer case entered by a user on the user electronic device.

At step 218, the control circuit determines words in the new customer case, compares the words in the new customer case to words in the dictionary, and, determines an action based upon the comparison. The action is one or more of sending an electronic message to an employee in a store to investigate, sending a first control signal to the automated vehicle to investigate, or sending a second control signal to the automated vehicle to remove the product from the store.

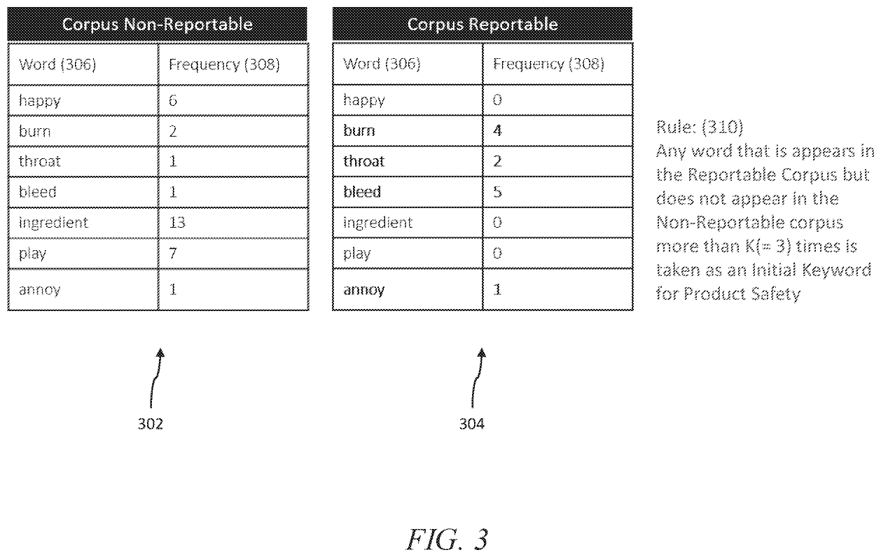

Referring now to FIG. 3, one example of a non-reportable matrix (or corpus) 302 and a reportable matrix (or corpus) 304 are described. Each of the matrices 302 and 304 has a first column 306 of words in the matrix (representing words in the non-reportable cases). Each of the matrices 302 and 304 has a second column 308 of words in the matrix (representing words in the reportable cases). For example, the word “happy” occurs 6 times in the matrix 302, meaning “happy” has occurred 6 times in the non-reportable cases.

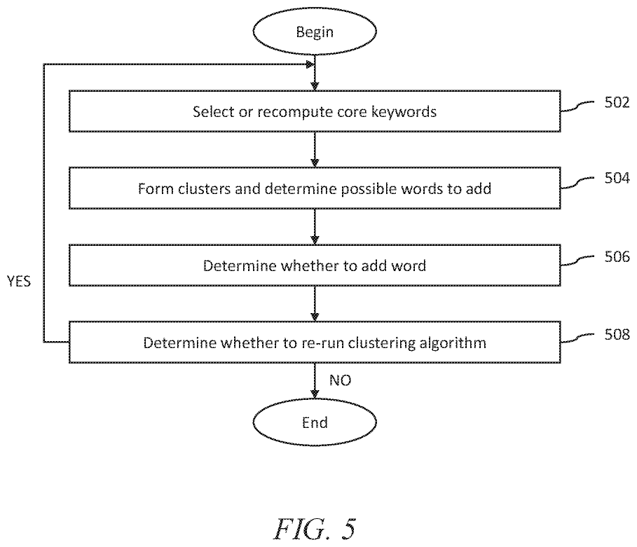

A rule 310 defines how an initial group of keywords for the dictionary will be selected. In this case, the rule specifies that any word that appears in the reportable matrix 304 but does not appear in the non-reportable matrix 302 more than k times (e.g., k=3) is selected as an initial keyword for product safety. In this case, “burn,” “throat,” “bleed,” and “annoy” appear in the reportable matrix 304 but do not appear in the non-reportable matrix 302 more than k times (k=3). Consequently, “burn,” “throat,” “bleed,” and “annoy” are selected as initial keywords. As described elsewhere herein (e.g., with respect to FIG. 5), clustering approaches are used to refine this listing to create a final dictionary of words.

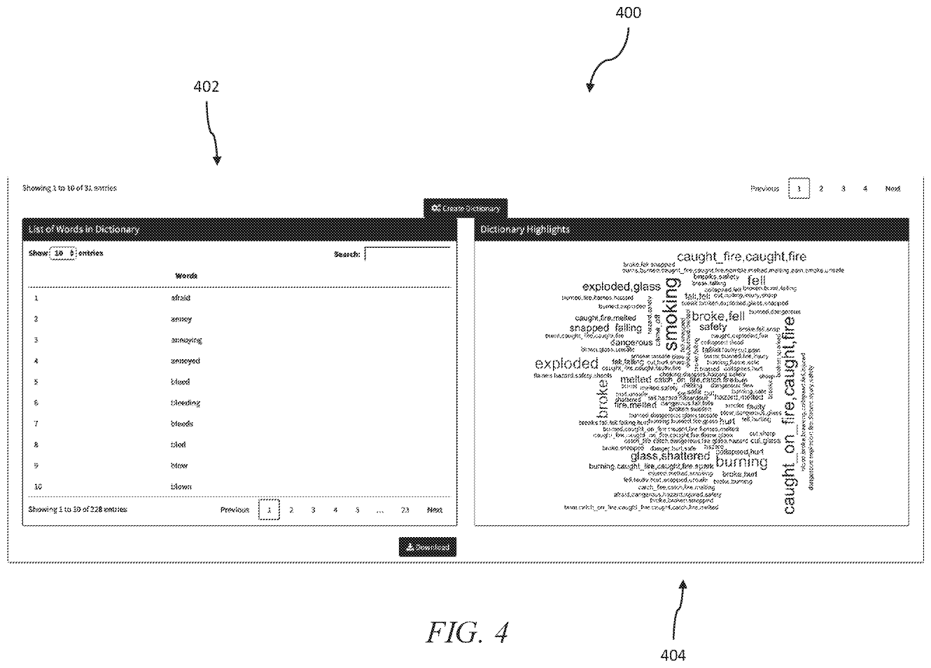

Referring now to FIG. 4, one example of a dictionary 400 is described. The dictionary 400 may include a listing 402 (that lists words in the dictionary over 23 pages according to this example). A word cloud diagram 404 may highlight various words in the dictionary.

Referring now to FIG. 5, one example of an approach for creating a dictionary using clustering is described. This approach focusses on each keyword to see if the keyword is adequate and/or should be supplemented.

At step 502, various core keywords are selected, and it will be appreciated that the entire vocabulary (both contextual and universal) is the population space. At step 504, clusters are formed around the various core keywords (points). In one example, if the core keywords are “choke,” “die,” “fire,” “hurt,” “cut,” and “electrocute,” a decision might be made to add “smoke” (to a cluster focused on fire) or “suffocating” (to a cluster focused on “choke”). The words to add may be obtained globally (e.g., “suffocating” may be synonymous with choking) or may be words from the reportable and/or non-reportable matrix.

At step 506, the decision is to whether to add the word to a cluster (either add the word or replace the word) and the core points using relative local density approaches. Once the first set of clusters are formed, the core keywords are re-computed via relative local density and direct reachability approaches, which are known to those skilled in the art. A keyword is a core keyword if its relative local density is higher than a given threshold or, it is directly reachable from another core keyword.

At step 508, a decision is made whether to re-run the clustering algorithm. In aspects, the algorithm is re-run until two successive iterations produce near-similar results, i.e., the total set of words comprising the dictionary does not change beyond a limited value over two successive iterations. If the decision is made to re-run the algorithm, execution continues at step 502, as described above, where clustering is again performed (beginning with re-computing the core keywords). The core keywords are based on the immediate clusters and then the clustering algorithm is run around the newly computed core keywords.

If the decision is made not to re-run the algorithm, then execution ends.

In some embodiments, one or more of the exemplary embodiments include one or more localized IoT devices and controllers (e.g., included with or associated with the various devices, sensors, or robots described herein). In another aspect, the user electronic devices or automated vehicles may be seen as an IoT device. As a result, in an exemplary embodiment, the localized IoT devices and controllers can perform most, if not all, of the computational load and associated monitoring and then later asynchronous uploading of data can be performed by a designated one of the IoT devices to a remote server. In this manner, the computational effort of the overall system may be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of data may include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modelled future states which may, for example, reflect generic background data. In an exemplary embodiment, KRG incrementally sequences all future undefined cached kernals of data in order to filter out data that may reflect generic background data. In an exemplary embodiment, KRG incrementally sequences all future undefined cached kernals having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data. In an exemplary embodiment, KRN and KRI, also incrementally sequences all future undefined cached kernels having encoded asynchronous data in order to filter out data that may reflect generic background data.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system, the system comprising:
a retail store, the retail store including an employee and an automated vehicle;
a user electronic device;
an electronic communication network coupled to the user electronic device;
a database disposed at a central location, the database including a small set of reportable customer cases, the set of reportable customer cases being labeled as reportable and being customer-reported communications having verified safety concerns that are reportable to an authority, wherein the database also includes a set of un-labeled customer cases, the un-labeled customer cases not being labeled as either reportable or non-reportable;
a control circuit disposed at the central location, the control circuit coupled to the database and the electronic communication network, wherein the control circuit is configured to:
for each case in the set of un-labeled customer cases, determine a metric, wherein the un-labeled customer cases are customer-reported communications from a customer having an associated type, the metric being a summation of a sentiment score and a similarity score;
identify, using a positive un-labeled (PU) classification learning approach, a set of non-reportable customer cases from the set of un-labeled customer cases based upon the type of case, the metric, and vector distances between cases in the set of un-labeled customer cases and cases in the set of reportable customer cases;
using the set of non-reportable customer cases, create a non-reportable matrix, the non-reportable matrix having a frequency of words in the set of non-reportable cases, and store the non-reportable matrix in the database;
using the set of reportable cases, create a reportable matrix, the reportable matrix having a frequency of words in the set of reportable cases, and store the reportable matrix in the database;
compare words in the reportable matrix to words in the non-reportable matrix, and for any word that appears in the reportable matrix and not in the non-reportable matrix more than a predetermined amount of times, add the word as an initial keyword in a keyword set, the keyword set comprising one or more so-identified keywords;
form a dictionary by iterating on the keyword set, the iterating forming clusters around keywords in the keyword set, the iterating, at each iteration, determining whether to add or delete keywords from the keyword set and re-compute the keywords based on relative local density, global and contextual word embedding;
wherein the control circuit subsequently receives a new customer case entered by a user via the user electronic device, determines words in the new customer case, compares the words in the new customer case to words in the dictionary, and, determines an action based upon the comparison;
wherein the action is one or more of sending an electronic message to an employee in a store to investigate, sending a first control signal to the automated vehicle to investigate, or sending a second control signal to the automated vehicle to remove the product from the store.

2. The system of claim 1, wherein the type of case is a compliment, a suggestion, an enquiry, a product performance review, a property damage report, or a complaint.

3. The system of claim 1, wherein the sentiment score relates to an emotional strength of words, the emotional strength of each of the words being set to a predetermined value.

4. The system of claim 1, wherein the similarity score is the average semantic distance between a case in the un-labeled set of customer cases and a case in the set of reportable customer cases.

5. The system of claim 1, wherein the iterating obtains potential keywords to add to the keyword set by consulting the reportable matrix to words and the non-reportable matrix using contextual word embedding.

6. The system of claim 1, wherein the iterating obtains potential keywords to add to the keyword set by consulting a global embedding source and a contextual embedding source using relative local density.

7. The system of claim 1, wherein the iterating continues until successive iterations produce identical results.

8. The system of claim 1, wherein the automated vehicle is an automated ground vehicle or an aerial drone.

9. A method, the method comprising:
providing an automated vehicle at a retail store, the retail store including an employee;
providing a user electronic device and an electronic communication network;
providing a database that is disposed at a central location, the database including a small set of reportable customer cases, the set of reportable customer cases being labeled as reportable and being customer-reported communications having verified safety concerns that are reportable to an authority, wherein the database also includes a set of un-labeled customer cases, the un-labeled customer cases not being labeled as either reportable or non-reportable;
providing a control circuit disposed at the central location;
at the control circuit and for each case in the set of un-labeled customer cases, determining a metric, wherein the un-labeled customer cases are customer-reported communication from a customer having an associated type, the metric being a summation of a sentiment score and a similarity score;
at the control circuit, identifying, using a positive un-labeled (PU) classification learning approach, a set of non-reportable customer cases from the set of un-labeled customer cases based upon the type of case, the metric, and vector distances between cases in the set of un-labeled customer cases and cases in the set of reportable customer cases;
at the control circuit and using the set of non-reportable customer cases, create a non-reportable matrix, the non-reportable matrix having a frequency of words in the set of non-reportable cases, and storing the non-reportable matrix in the database;
at the control circuit and using the set of reportable cases, creating a reportable matrix, the reportable matrix having a frequency of words in the set of reportable cases, and storing the reportable matrix in the database;
at the control circuit, comparing words in the reportable matrix to words in the non-reportable matrix, and for any word that appears in the reportable matrix and not in the non-reportable matrix more than a predetermined amount of times, adding the word as an initial keyword in a keyword set, the keyword set comprising one or more so-identified keywords;
at the control circuit, forming a dictionary by iterating on the keyword set, the iterating forming clusters around keywords in the keyword set, the iterating, at each iteration, determining whether to add or delete keywords from the keyword set and re-computing the keywords based on relative local density, global and contextual word embedding;
wherein the control circuit subsequently receives a new customer case entered by a user via the user electronic device, determines words in the new customer case, compares the words in the new customer case to words in the dictionary, and, determines an action based upon the comparison;
wherein the action is one or more of sending an electronic message to an employee in a store to investigate, sending a first control signal to the automated vehicle to investigate, or sending a second control signal to the automated vehicle to remove the product from the store.

10. The method of claim 9, wherein the type of case is a compliment, a suggestion, an enquiry, a product performance review, a property damage report, or a complaint.

11. The method of claim 9, wherein the sentiment score relates to an emotional strength of words, the emotional strength of each of the words being set to a predetermined value.

12. The method of claim 9, wherein the similarity score is the average semantic distance between a case in the un-labeled set of customer cases and a case in the set of reportable customer cases.

13. The method of claim 9, wherein the iterating obtains potential keywords to add to the keyword set by consulting the reportable matrix to words and the non-reportable matrix using contextual word embedding.

14. The method of claim 9, wherein the iterating obtains potential keywords to add to the keyword set by consulting a global embedding source.

15. The method of claim 9, wherein the iterating continues until successive iterations produce identical results.

16. The method of claim 9, wherein the automated vehicle is an automated ground vehicle or an aerial drone.
